(19) United States
(12) Patent Application Publication
(10) Pub. No.: US 2010/0256963 A1
(43) Pub. Date: Oct. 7, 2010

(54) EVALUATING METHOD FOR INTEGRITY OF VIBRATION OF STEAM DRYER AND TEST DEVICE STEAM DRYER

(76) Inventors: Shiro TAKAHASHI, Hitachi (JP); Masaya Ohtsuka, Mito (JP); Koji Nishida, Hitachiota (JP); Takashi Ito, Hitachi (JP); Yasuhiro Mabuchi, Mito (JP); Akinori Tamura, Hitachi (JP); Masaaki Tsubaki, Hitachi (JP); Keita Okuyama, Hitachi (JP); Kazuhiro Yoshikawa, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/730,440

(22) Filed: Mar. 24, 2010

(30) Foreign Application Priority Data
Mar. 31, 2009 (JP) 2009-083976

(51) Int. Cl. G06G 7/57; G01F 1/20

(52) U.S. Cl. 703/9; 73/861.18

(57) ABSTRACT

The object of the invention is to accurately evaluate integrity of vibration of a dryer of an actual system.

The evaluating method for integrity of vibration of a steam dryer using a reduced model in a nuclear plant including the steam dryer for reducing moisture of steam generated inside a steam dome of a nuclear reactor pressure vessel, and a plurality of main steam pipes for transporting the steam to outside includes the steps of performing a steam test with the reduced model, calculating fluctuating stress applied to the steam dryer, and confirming integrity of vibration.

According to the invention, it is possible to evaluate the pressure fluctuation of a dryer of an actual system more accurately.

### CLAIM OF PRIORITY

The present application claims priority from Japanese Patent application serial No. 2009-083976 filed on Mar. 31, 2009, the content of which is hereby incorporated by reference into this application.

### BACKGROUND OF THE INVENTION

The present invention relates to an evaluating method for integrity of vibration of a steam dryer and a test device of the steam dryer.

Japanese Published Unexamined Patent Application No. 2007-127633 discloses a technique for performing a scale down test simulating a main steam line equipped with a steam dome of a nuclear reactor, a dryer (steam dryer), and main steam pipes with an air flow which can be handled conveniently and can realize a large flow rate, and evaluating acoustic loading of the steam dryer.

### SUMMARY OF THE INVENTION

The steam flows in the main steam pipes of an actual system, whereas air flows in the scale down test according to Japanese Published Unexamined Patent Application No. 2007-127633. Because the property of the steam and air are different, when a pressure (load) fluctuation phenomenon of the actual system is to be estimated, a similarity rule of the pressure fluctuation phenomenon becomes important. Also, the scale down test using an air flow had a problem that influence of liquid droplets contained in the steam could not be simulated. Therefore, a technique in which property is made more similar to that of an actual system was necessary in order to reduce the influence of a similarity rule and improve evaluation accuracy.

The object of the invention is to accurately evaluate integrity of vibration of a dryer of an actual system.

A method for evaluation according to an embodiment of the invention is an evaluating method for integrity of vibration of a steamdryer using a reduced model in a nuclear plant including the steam dryer for reducing moisture of the steam generated inside a steam dome of a nuclear reactor pressure vessel, and a plurality of main steam pipes for transporting the steam to outside, which includes the steps of performing a steam test with the reduced model, calculating fluctuating stress applied to the steam dryer, and confirming integrity of vibration.

A test device of a steam dryer according to an embodiment of the invention is a test device of a steam dryer manufactured for evaluating integrity of vibration of the steam dryer in a nuclear plant including the steam dryer for reducing moisture of the steam generated inside a steam dome of a nuclear reactor pressure vessel and a plurality of main steam pipes for transporting the steam to outside. The test device includes a plate-like member fixing the steam dryer to the steam dome, a partition plate dividing a space on an upper face side of the plate-like member, and sluice valves disposed in the main steam pipes and switching the main steam pipes to which the steam flows in from the steam dome.

According to an embodiment of the invention, more accurate evaluation of integrity of vibration of a dryer of an actual system becomes possible.

### BRIEF DESCRIPTION OF THE DRAWINGS

FIG. 1 is a schematic view of a test device of a BWR main steam line according to a first embodiment;

FIG. 2 is a schematic view (top view) of the test device of a BWR main steam line according to the first embodiment;

FIG. 3 is a schematic view (top view) of the test device of a BWR main steam line according to the first embodiment;

FIG. 4 is a block diagram of a procedure for evaluating integrity of a BWR dryer according to the first embodiment;

FIG. 5 is a schematic drawing of a procedure for evaluating pressure fluctuation of a BWR dryer according to a second embodiment;

FIG. 6A is a drawing when a plate-like member of FIG. 2 is viewed from below; and

FIG. 6B is a drawing when a plate-like member of FIG. 3 is viewed from below.

### DETAILED DESCRIPTION OF THE PREFERRED EMBODIMENTS

Below, embodiments will be described.

### First Embodiment

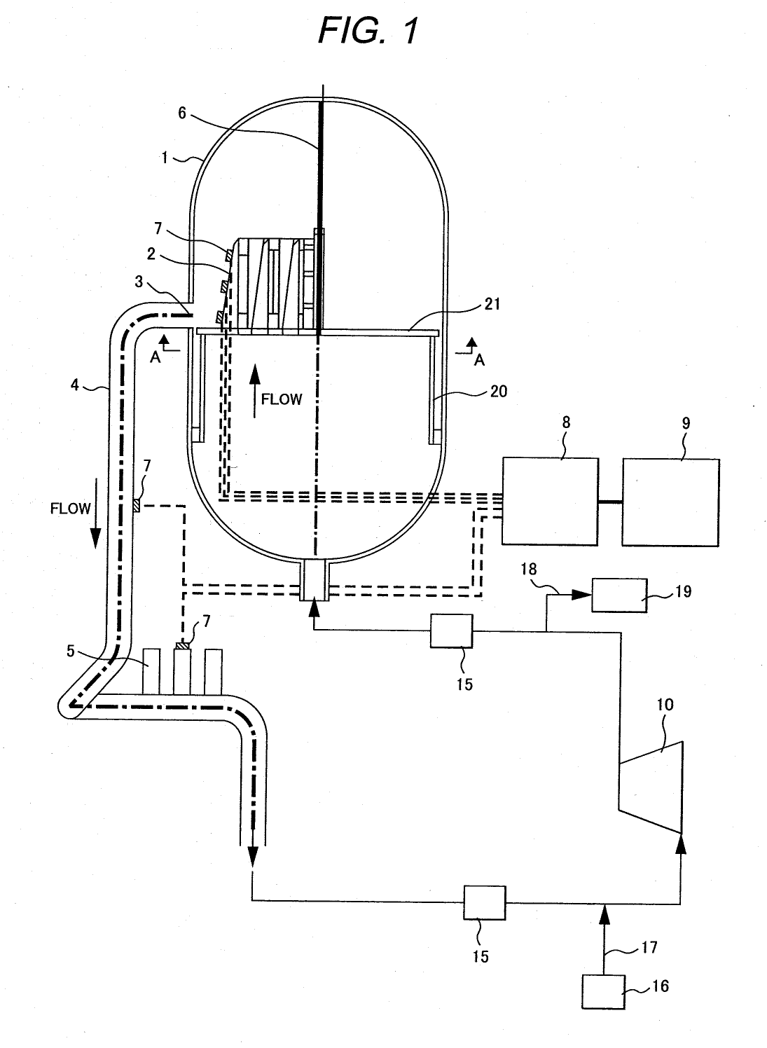

FIG. 1 is a schematic view of a test device for a BWR main steam line according to the present embodiment. In the embodiment, a steam dome 1 simulating an upper part of a nuclear reactor of an actual system, a steam dryer (dryer) 2 arranged inside the steam dome, main steam nozzles 3, and main steam pipes 4 are provided. Also, a plurality of stub tubes 5 for steam relief valves and the like are arranged on the main steam pipes 4. These equipment and structures are manufactured reducingly simulating an actual system. The steam that has flown through the main steam pipes 4 is compressed by a steam compressor 10 disposed downstream. The steam compressor 10 pressurizes the steam and feed the steam again from a lower part of the steam dome 1.

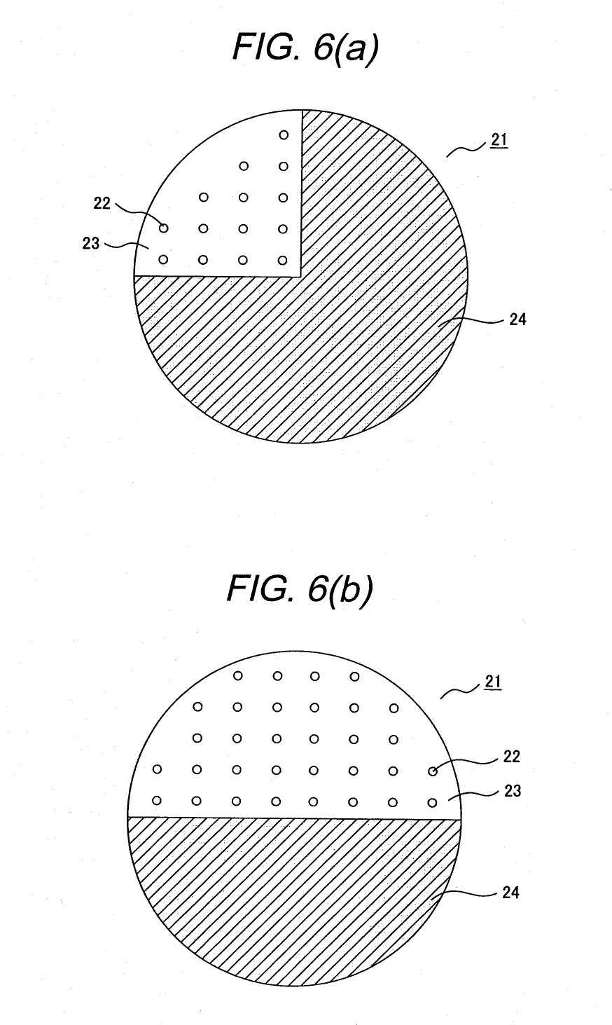

More specifically, the steam dryer (dryer) 2 is arranged on an upper face of a plate-like member 21. A dryer skirt 20 is a cylindrical structural member and is joined with a lower face of the plate-like member 21. Also, a lower end of the dryer skirt 20 is joined with the steam dome 1. A partition plate 6 described below is arranged so as to partition a space on the upper face side of the plate-like member 21. Further, the plate-like member 21 includes a plurality of holes 22 (FIG. 6A and FIG. 6B) for feeding the steam from the steam compressor 10 to the dryer 2. Detailed configuration of FIG. 6A and FIG. 6B will be described separately.

Sensors 7 are arranged in the dryer 2, the main steam pipes 4, and the stub tubes 5 respectively. A measuring instrument 8 measures pressure by a signal from the sensors 7, and a computer 9 calculates stress from the pressure.

In a line that returns the steam having flown from the main steam pipes 4 to the steam compressor 10, a silencer 15 and a water spray device 16 spraying droplets 17 to the steam are arranged. In a line that feeds the steam from the steam compressor 10 to the steam dome 1, a drain water tank 19 for storing discharged drain water 18 and a silencer 15 are arranged.

Also, the diameter of a horizontal cross-section of the steam dome 1 of the test device is 1 m or below, whereas that of the actual system is 5-6 m.

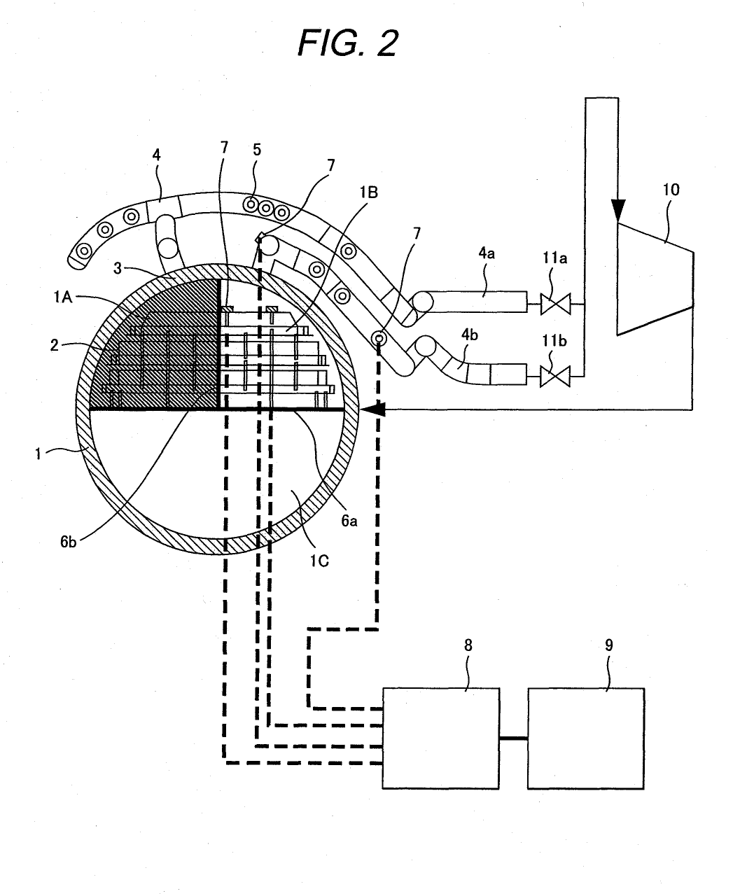

FIG. 2 is a top view of the test device according to the embodiment. The partition plate 6 divides a space on the upper face side of the plate-like member 21 arranged in the steam dome 1 into three. The divided spaces inside the steam dome are referred to as a space 1A, 1B, 1C respectively. Also, the test device includes a main steam pipe 4a to which the steam flows in from the space 1A, and a main steam pipe 4b to which the steam flows in from the space 1B. In FIG. 2, two lines are shown, and a test can be performed for each line by being switched by valves 11a, 11b (sluice valve). Further, 4 lines of main steam pipes are arranged in an actual system, however 2 lines are eliminated in the test device. Therefore, in the test device, a dryer and a main steam pipe to which the steam flows in for the space 1C are omitted.

More specifically, the partition plate 6 is constructed of two members 6a, 6b. The member 6a is arranged so as to partition the horizontal cross-section of the steam dome 1 into ½ each. Also, the member 6b is arranged so as to partition the horizontal cross-section of the space on the main steam pipes 4a, 4b side out of the space partitioned by the member 6a into ½ each. Further, the member 6b may be arranged so as to partition the horizontal cross-section of the steam dome 1 into ½ each, as the member 6a does, to divide the space on the upper face side of the plate-like member 21 into four.

Furthermore, because the cylindrical steam dome 1 is used in the embodiment, the space on the upper face side of the plate-like member 21 becomes three spaces of 1A, 1B, 1C. However, the spaces used in the test are only 1A and 1B. Consequently, the plate-like member 21 is devised so that the steam flows into the space 1A (1B) only. FIG. 6A shows a view A-A in FIG. 1 of the plate-like member 21. In the plate-like member 21, the holes 22 are formed only in a fan-shape region 23 occupying ¼ of the entire area, and holes of a remaining region 24 are blocked. Therefore, when the space 1A (1B) is to be tested, the plate-like member 21 is arranged so that steam flows into the space 1A (1B) through the holes 22 of the fan-shape region 23. By blocking the holes of the region 24 that occupies ¾ out of the entire area of the plate-like member 21, the steam can be fed only to the space 1A (1B), and the steam compressor can be made compact.

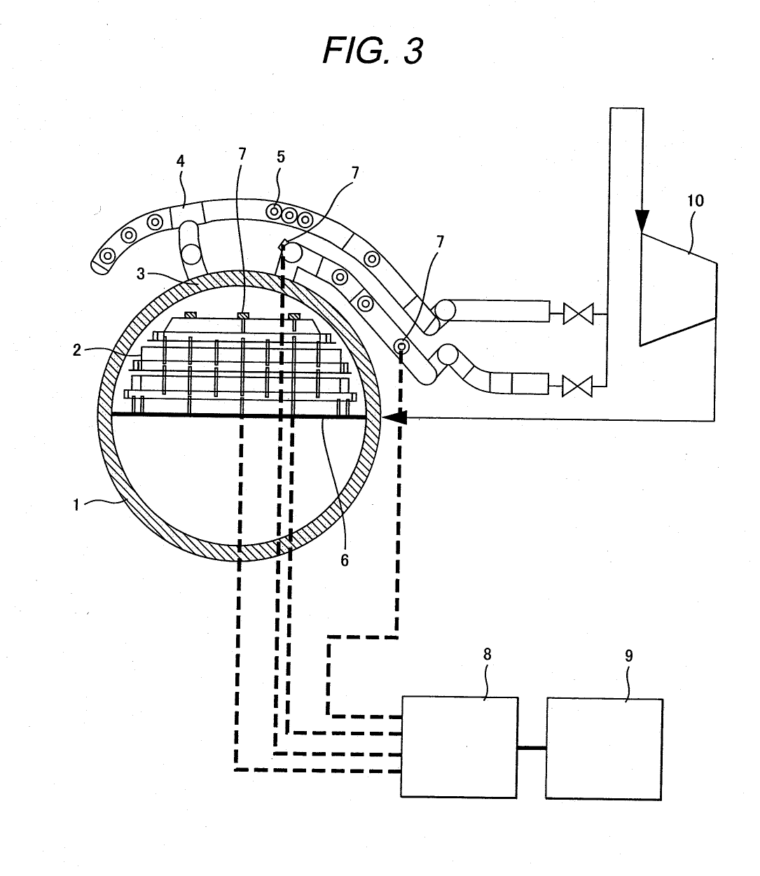

Further, it is also possible to divide the space on the upper face side of the plate-like member 21 into two. FIG. 3 is the top view of the test device of the case the space is divided into two. Also, FIG. 6B shows the plate-like member 21 of the case in that the space is divided into two. In the plate-like member of the case in that the space is divided into two, the holes 22 are formed only in the ½ region 23 and holes in the remaining ½ region 24 are blocked.

The dryer 2 of the actual system is an apparatus for separating water droplets by corrugated plates arranged inside the dryer 2 and drying the steam (separating water droplets) with respect to the steam flowing from the lower part. The test device is manufactured mainly by simulating appearance and a flow passage configuration of the dryer 2. The steam having passed the dryer 2 causes convection inside the steam dome 1, and flows into the main steam pipes 4 through the main nozzles 3. When steam passes the stub tube 5 for a steam relief valve of the main steam pipe 4, pressure waves resonate inside a closed branch pipe of the stub tube and pressure pulsation is generated. The pressure pulsation generated is transmitted as far as the dryer 2 through the main steam pipe 4. The present test device can also reproduce pressure pulsation generated in a flow around the main steam nozzles 3 of the steam dome 1 and the dryer 2.

In the embodiment, steam flow rate is limited by steam generating capacity of the steam compressor 10. Therefore, the main steam pipes 4 connected to the steam dome 1 are arranged respectively simulating 2 lines to which the steam of the spaces 1A and 1B flows in. Thereby, steam flow rate required for the test is inhibited. However, if only some numbers of lines of the main steam pipes 4 are arranged, a steam flow inside the steam dome 1 may possibly changes. Therefore, the partition plate 6 dividing the inside of the steam dome 1 into three (four) is arranged, and the condition of the steam flow inside the steam dome 1 is brought closer to that of the actual system. Further, the test is performed in plural times by exchanging or switching each line of the main steam pipes 4, and characteristics of pressure pulsation generated in each main steam pipe are evaluated.

The pressure pulsation generated can be measured by the sensors 7 arranged in the steam relief valve stub tubes 5, the main steam pipes 4, the dryer 2, and the like. Electric signals obtained by the sensors 7 are processed by the measuring instrument 8 and are evaluated by the computer 9 as pressure fluctuation, displacement fluctuation, or stress fluctuation. The function of the measuring instrument 8 is to take analog voltage output signals from the sensors in, to convert to digital data, and to record them. In the computer 9, a voltage signal measured by the measuring instrument 8 is converted to a value of strain, acceleration, and pressure. Then, from the obtained value of strain, acceleration, and pressure, the stress generated on the dryer is analyzed.

For the sensor 7, a strain gauge, accelerometer, pressure gauge or the like is used. With respect to the pressure gauge and accelerometer, pressure fluctuation distribution and displacement fluctuation distribution inside the steam dome are evaluated using the pressure fluctuation and acceleration of plural points measured. The pressure fluctuation distribution is the distribution representing the magnitude of the pressure fluctuation (pressure amplitude) in a constant time in a space inside the steam dome. Then, the stress fluctuation distribution generated on the dryer is calculated by structural analysis and the like. Also, when the strain gauge is used, the stress fluctuation can be evaluated from the obtained strain fluctuation based on an equation (1) below.

Stress fluctuation=modulus of longitudinal elasticity×strain fluctuation (1)

When the stress fluctuation of the dryer thus obtained satisfies an inequality (2) below with respect to the fatigue limit of material, the integrity of vibration of the dryer can be evaluated to be sound.

Safety factor×stress fluctuation<fatigue limit of material (stress fluctuation value) (2)

By a series of evaluation procedures described above, integrity of vibration of the dryer with respect to high cycle fatigue can be evaluated.

By simulating the main steam pipes 4 on respective lines as described above, the steam flow velocity inside the main steam pipes 4 can be made as high as or higher than that of the actual system with a simpler test device. As a result, it becomes possible to generate the pressure pulsation inside the steam relief valve stub tube 5 by the steam flow and to evaluate the transmission characteristic of the pressure pulsation by the test device.

Also, by arranging the partition plate 6 inside the steam dome, the flow condition inside the steam dome is brought closer to the condition of the actual system. Further, by making the partition plate 6 of a material causing absorption or reflection of the sound, the partition plate becomes a boundary condition of the sound (pressure pulsation), and the tests can become possible under a variety of conditions. Particularly, when the pressure pulsations generated in respective main steam pipes are to be composed, it is preferable to provide a silencing function in order to reduce an influence of the partition plate. The partition plate is manufactured preferably by a silencing material such as a perforated plate, perforated material, porous material, corrugated plate, glass wool, nonwoven fabric, textile, ceramic, and spray material. Also, it is effective to arrange one or a plurality of the partition plate and silencing equipment.

The knowledge described above is based on the fact that, when the steam flowing inside the steam dome of the actual system is viewed in a horizontal cross-section, the steam flow is symmetric with respect to the fan-shape region occupying ¼ of the horizontal cross-section. Therefore, by arranging the partition plate in the steam dome so as to allow a symmetric flow, the flow similar to that when symmetry is maintained is realized by the partition plate. Consequently, when the partition plate is not provided in FIG. 2 and the steam flows through the main steam pipe 4b only, it is presumed that the flow becomes an asymmetrical flow without symmetry.

Also, it is necessary to arrange the partition plate 6 so as not to obstacle a flow of the steam flowing in to the main steam nozzles 3. Accordingly, it is preferable to arrange the partition plate 6 in the orthogonal direction to the dryer bank face and the horizontal direction as shown in FIG. 1, FIG. 2 and FIG. 3. That is, the partition plate 6 is arranged so that the divided dryer is configured symmetrically. Further, in order to confirm the characteristic of the pressure pulsation, it is necessary to faithfully miniaturize the shape of the actual system, and to divide the space above the plate-like member into three (four) or two.

Furthermore, in order to inhibit the noise generated by the steam compressor and the valves in the test loop, it is preferable that a silencer or the like is arranged in an inlet and an outlet of the test device. In addition, by making the horizontal cross-section of the steam dome 1 semi-circular or fan-shape instead of arranging the partition plate 6, a similar effect as that of the embodiment can be obtained.

Only by such simplifications, the steam test became possible. Also, according to the embodiment, since it is enough just to prepare reduced models of the dryer 2 belonging to the spaces 1A, 1B and the main steam pipes 4 to which the steam flows in from the space 1A, 1B, the number of members to be manufactured can be reduced and the manufacturing cost of a test body can be lowered. Also, the capacity of steam circulation facilities can be lowered, and the manufacturing cost of the steam test loop can be reduced as well. Further, another feature of the embodiment is that all of the strength of the pressure pulsation generated in the steam relief valve stub tube 5, the transmission characteristic of the pressure pulsation of the main steam line, and the pressure fluctuation load applied to the dryer 2 can be evaluated directly based on the values measured in the test.

In order to evaluate the characteristic of the pressure fluctuation, the test device is provided with the pressure sensors, strain gauges, accelerometers, and displacement gauges in respective locations. When a technique in which an acoustic velocity is obtained from the difference of the property fluctuation among a plurality of points and the property is evaluated is employed, the pressure fluctuation can be evaluated more accurately. Also, when the strain gauges are arranged on the main steam pipes 4, if the pipe thickness is thick, the sensitivity of the sensor lowers. Therefore, by making only the sensor attaching section thin, measurement can be performed with high accuracy while securing safety. In particular, a straight pipe section of a descending pipe arranged in the vicinity of the main steam nozzle 3 is close to the dryer 2 inside the steam dome 1. Therefore, it is preferable to arrange the strain gauges with the thickness of the straight pipe section being changed to thin.

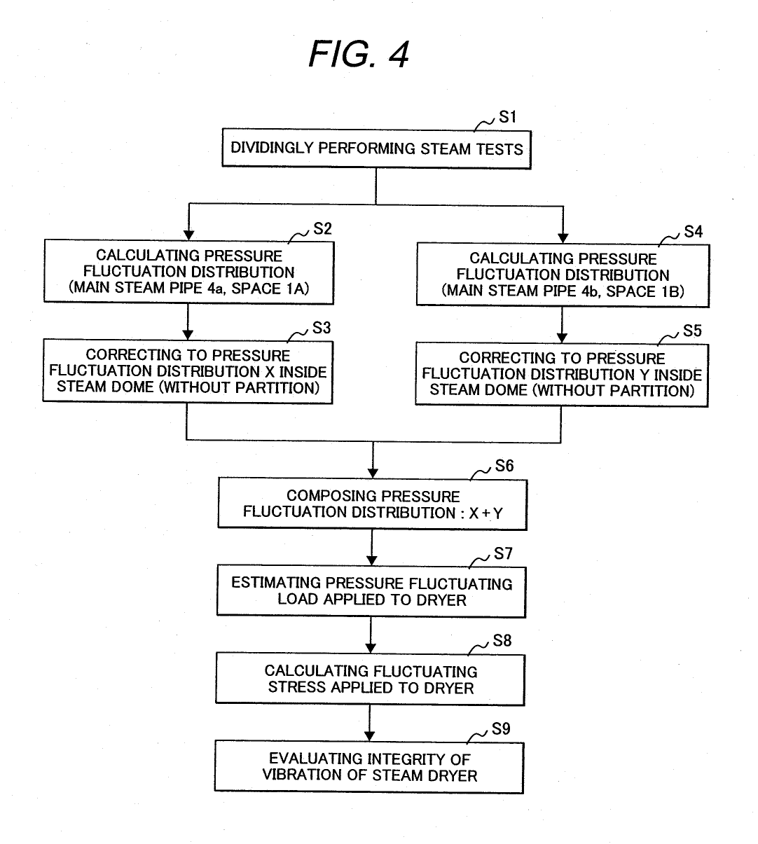

FIG. 4 shows a procedure for evaluating integrity of a BWR dryer according to the embodiment. In the evaluation technique, the test is performed on each main steam pipe that is different in shape. Therefore, in step S1, the inside of the steam dome is divided by the partition plate, and the tests are performed plural times.

First, in order to test the pressure fluctuation distribution of the space 1A, the steam is fed to the main steam pipe 4a through the space 1A. Then, the pressure fluctuation distribution of the space 1A is calculated as step S2. In this case, the space of the steam dome is divided, and the shape of the space is different from the shape of the actual system. Therefore, in step S3, the pressure fluctuation distribution of the space 1A is corrected by an analysis to the pressure fluctuation distribution X inside the steam dome without the partition plate which is similar to the actual system. This correction can be performed by an acoustic analysis. In this regard, the acoustic analysis is performed for each case with the partition plate and without the partition plate, and the influence of presence/absence of the partition plate is evaluated. Thus, it is possible to correct the pressure fluctuation distribution of the case with the partition plate to the pressure fluctuation distribution of the case without the partition plate.

Similarly, in order to test the pressure fluctuation distribution of the space 1B, the steam is fed to the main steam pipe 4b through the space 1B. Then, the pressure fluctuation distribution is calculated in the space 1B as step S4. Next, in step S5, from the pressure fluctuation distribution in the space 1B, a pressure fluctuation distribution Y inside the steam dome without the partition plate is calculated by correction. The calculation method for the pressure fluctuation distribution Y is similar to that for the pressure fluctuation distribution X.

In step S6, by adding up the pressure fluctuation distribution X and Y described above, the pressure fluctuation distribution when the steam is fed to the main steam pipes 4a, 4b from the steam dome can be calculated. Because the sound (pressure pulsation) can be linearly treated, the pressure fluctuation distribution by the main steam pipes 4a, 4b can be calculated by adding up the individual pressure fluctuation distribution. As described above, the pressure fluctuation distribution of the entire space inside the steam dome 1 (the space totaling the spaces 1A, 1B, 1C) is estimated by adding up two pressure fluctuation distribution evaluated in the tests for the main steam pipes 4a, 4b.

A technique for adding up the pressure fluctuation distribution will be described more specifically. If the pressure of a time point t is X1 in the coordinate a of the pressure fluctuation distribution X and the pressure of a time point t is Y1 in the coordinate a of the pressure fluctuation distribution Y, the pressure added up can be evaluated by X1+Y1.

Also, in step S7, the pressure fluctuating load applied to the dryer 2 is estimated and evaluated based on the pressure fluctuation distribution in the entire space inside the steam dome. Further, when the pressure fluctuation distribution obtained in respective main steam pipes is to be overlapped, the phase of each pressure fluctuation distribution should be considered. The actual phenomena have no correlation between each line. Therefore, evaluation is made conservatively so as to increase the pressure fluctuation (fluctuating stress) by imparting a variety of phase variations.

Then, the calculated pressure fluctuating load is inputted to a structural analysis model simulating the dryer 2. The pressure fluctuating load is measured under a steam condition equivalent to that of the actual system. Therefore, the measured values can be inputted to the analysis model only by simple alteration of frequency and the like. The structural analysis is thus performed in step S8, and the fluctuating stress applied to each portion of the dryer 2 is calculated.

Lastly in step S9, integrity of vibration of the dryer 2 is confirmed by comparing the calculated fluctuating stress with the fatigue limit of the material.

More specifically, integrity of vibration of the dryer is evaluated to be sound when the inequality (2) is satisfied, and integrity of vibration of the dryer is evaluated to have a problem when the inequality (2) is not satisfied.

As described above, integrity of vibration of the actual dryer can be evaluated with high accuracy by performing the steam test on the reduced model simulating the main steam pipes and the steam relief valve stub tube arranged on the main steam pipes.

In performing the steam test on the reduced model, if the entirety of the steam dome and the steam dryer (dryer) is to be modeled, the scale of the test becomes large. Accordingly, the required steam flow rate becomes enormous, and it becomes hard to perform the test. Therefore, according to the embodiment, as a measure for reducing a spatial region in the steam dome, the partition plate is arranged inside the steam dome and the actual system is partly modeled. An influence affecting to generation and strength of the pressure pulsation inside the main steam pipes by equipment inside the steam dome (steam dryer) is small. Therefore, the partition plate can be arranged inside the steam dome to divide the space inside the steam dome.

Also, the inventors found out that the pressure pulsations of respective main steam pipes showed a weak correlation with each other. Therefore, the line of themain steam pipe is divided, and the steam test is performed plural times. Consequently, modeling of all lines is not required, and the scale can be reduced. Further, the magnitude of the pressure pulsation varies in characteristic and strength for each main steam pipe. Therefore, if the shape of the main steam pipe is different, the test must be performed on each main steam pipe.

Further, because the sound (pressure pulsation) can be linearly treated, the pressure pulsations measured in the individual main steam pipes can be composed. Furthermore, by adding up and evaluating respective pressure pulsations, the individual pressure pulsation applied to the dryer can be evaluated.

Also, by arranging a sound absorbing material on the partition plate, errors in overlapping the pressure pulsations can be reduced and the reflected waves generated at the partition plate can be controlled or inhibited.

The main steam pipes are manufactured reducingly to a degree the steam relief valve can be simulated. Only by such simplification, the test using the steam under the same condition with that of the actual system becomes possible. By arranging the dryer inside the steam dome and employing the steam for liquid, it becomes possible to evaluate integrity of vibration of the dryer directly with high accuracy by the sensors arranged in the dryer. Also, according to the embodiment, employment of the steam becomes possible. Further, by performing the test in which the steam relief valve stub tube is modeled, direct measurement and evaluation of the magnitude of the pressure pulsation generated in the steam relief valve stub tube and the like becomes possible. Furthermore, because it is difficult to secure the heat quantity for generating the steam for them, an operation in which the steam is circulated by a steam compressor is preferable.

The pressure pulsation that is generated inside the main steam pipes is also generated inside a dead leg, branch pipe, steam dome, and the like in addition to the steam relief valve stub tube. A similar technique can be applied to the pressure pulsation of them as well. The object of the embodiment is all pressure pulsations that may be generated inside the main steam pipe line and the steam dome.

### Second Embodiment

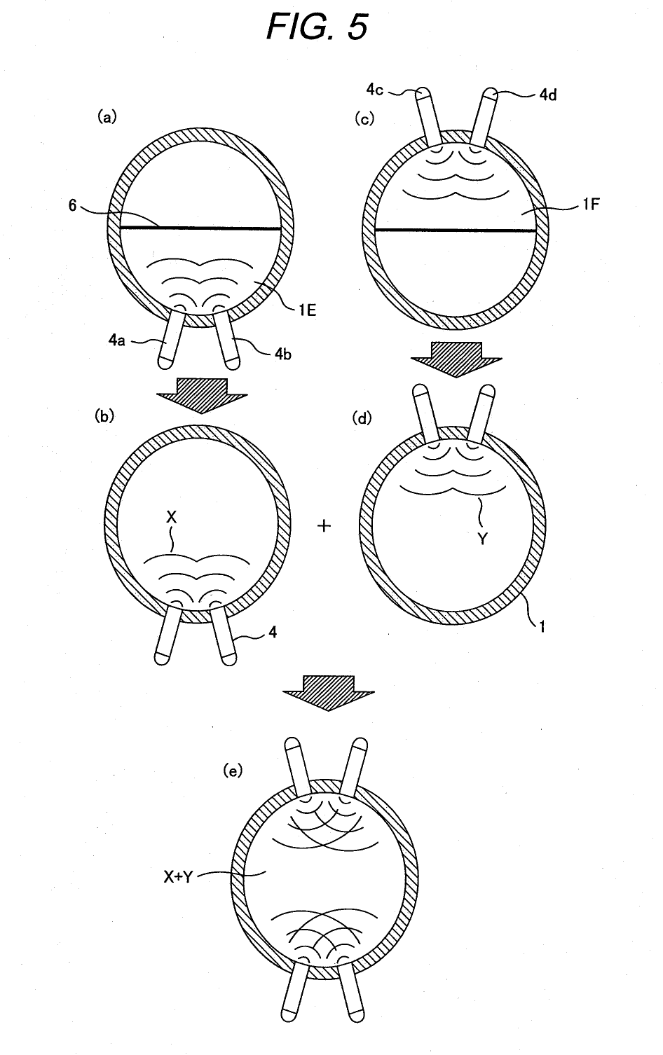

The present embodiment shows an exemplary case in which the space inside the steam dome is divided into two, and two lines of the main steam pipes are provided for each space. FIG. 5 is a schematic drawing of a procedure for evaluating pressure fluctuation of a BWR dryer according to the embodiment. As shown in FIG. 5, the space inside the steam dome is divided into two, 1E and 1F. Also, the main steam pipes to which the steam flows in from the space 1E are 4a, 4b, whereas the main steam pipes to which the steam flows in from the space 1F are 4c, 4d.

First, in the test, the steam flows into the main steam pipes 4a, 4b from the space 1E, and the pressure fluctuation distribution of the space 1E is calculated ((a) in FIG. 5). This pressure fluctuation distribution is corrected in the same manner as in the first embodiment, and the pressure fluctuation distribution X of the entire steam dome is calculated ((b) in FIG. 5). Similar calculation is performed with respect to the space 1F, and the pressure fluctuation distribution Y is calculated ((c), (d) in FIG. 5).

Then, by adding up the pressure fluctuation distribution X and Y, the pressure fluctuation distribution of a case in which the steam is fed to the main steam pipes 4a-4d from the steam dome can be calculated ((e) in FIG. 5).

The method for evaluating integrity of vibration of the dryer using this pressure fluctuation distribution is similar with that of the first embodiment.

What is claimed is:

1. An evaluating method for integrity of vibration of a steam dryer using a reduced model in a nuclear plant including the steam dryer for reducing moisture of steam generated inside a steam dome of a nuclear reactor pressure vessel and a plurality of main steam pipes for transporting the steam to outside, comprising the steps of:
performing a steam test with the reduced model;
calculating fluctuating stress applied to the steam dryer; and
confirming integrity of vibration.

2. The evaluating method for integrity of vibration of a steam dryer according to claim 1, further comprising the steps of:
performing steam tests plural times by switching the main steam pipe to which the steam flows in from the steam dome;
calculating pressure fluctuation distribution inside the steam dome; and
composing the pressure fluctuation distribution.

3. The evaluating method for integrity of vibration of a steam dryer according to claim 2, further comprising the step of dividing a space inside the steam dome by a partition plate.

4. The evaluating method for integrity of vibration of a steam dryer according to claim 3,
wherein one line or two lines of main steam pipe is connected to one space inside the steam dome formed by the partition plate.

5. The evaluating method for integrity of vibration of a steam dryer according to claim 3 or claim 4,
wherein the partition plate has a silencing function.

6. An evaluating method for integrity of vibration of a steam dryer using a reduced model simulating a part of main steam pipes in a nuclear plant including the steam dryer for reducing moisture of steam generated inside a steam dome of a nuclear reactor pressure vessel and a plurality of main steam pipes for transporting the steam to outside, comprising the steps of:
(1) feeding the steam from a first space that is formed by dividing the inside of the steam dome by a partition plate to a first main steam pipe and calculating pressure fluctuation distribution of the first space;
(2) calculating first pressure fluctuation distribution inside the steam dome based on the pressure fluctuation distribution of the first space;
(3) feeding the steam from a second space that is formed by dividing the inside of the steam dome by a partition plate to a second main steam pipe and calculating pressure fluctuation distribution of the second space;
(4) calculating second pressure fluctuation distribution inside the steam dome based on the pressure fluctuation distribution of the second space;
(5) composing pressure fluctuation distribution of a case in which the steam is fed to the first main steam pipe and the second main steam pipe based on the first pressure fluctuation distribution and the second pressure fluctuation distribution; and
(6) calculating fluctuating stress applied to the steam dryer based on the pressure fluctuation distribution calculated in the step (5) and evaluating integrity of vibration of the steam dryer.

7. A test device of a steam dryer manufactured for evaluating integrity of vibration of the steam dryer in a nuclear plant including the steam dryer for reducing moisture of steam generated inside a steam dome of a nuclear reactor pressure vessel, and a plurality of main steam pipes for transporting the steam to outside, comprising:
a plate-like member fixing the steam dryer to the steam dome;
a partition plate dividing a space on an upper face side of the plate-like member; and
sluice valves disposed in the main steam pipes and switching the main steam pipes to which steam flows in from the steam dome.
